(19) United States
(12) Patent Application Publication
(10) Pub. No.: US 2020/0281791 A1
(43) Pub. Date: Sep. 10, 2020

(54) Yoni Seat

(71) Applicant: Nedra JoLyn Miller, New Port Richey, FL (US)

(72) Inventor: Nedra JoLyn Miller, New Port Richey, FL (US)

(21) Appl. No.: 16/798,394

(22) Filed: Feb. 23, 2020

Related U.S. Application Data
(60) Provisional application No. 62/809,971, filed on Feb. 25, 2019.

(51) Int. Cl. A61G 15/00

(52) U.S. Cl. CPC A61G 15/005; A47C 1/04; A61G 2200/12

(57) ABSTRACT

The multipurpose chair will be constructed from one continuous piece of antimicrobial, nonporous, hard plastic such that no crevices are created that could harbor pathogens. The multipurpose chair may be internally steel reinforced for additional strength and durability. The seat base bottom will have a non-skid, non-slip surgace. The multipurpose chair will provide the user with a safe, sanitary and comfortable seat while offering stability and support in a variety of positions both in and out of the shower. The open front and central design providing access to intimate areas during childbirth, shaving, steaming and waxing.

### BACKGROUND OF THE INVENTION

### Problem

Some women may wish to perform hygienic and depilatory rituals such as shaving, waxing and steaming. Such women utilizing a standard chair or shower seat may find limitations in their ability to assume certain positions necessary to shave, wax or steam intimate areas. These limitations may cause some women to attempt certain positions that are unintended while using a standard chair or shower seat. This unintended use may lead to a slip or fall, potentially causing significant harm. In addition, the limitations of other chairs may cause some women to attempt to build their own chair, however, such devices may not be very safe, sanitary or comfortable. Therefore, a chair that offers the user a safe, sanitary, and comfortable means to position the body in such a way as to allow ease of access of intimate areas to performing hygienic and depilatory rituals both in and out of the shower is desired.

The field of Midwifery and the goal of each Midwife is to provide comfort and assistance to women across their lifespan, inclusive of the time during childbirth. Many women prefer a natural childbirth but struggle to find comfortable positions that would promote a natural birth. Women who labor at home may use an inflatable device, bed, furniture, shower seat, toilet or other household furniture to find a comfortable position during childbirth. Such women utilizing these commonly found items in the home may find limitations in their ability to assume certain positions whilst maintaining direct access of critical areas to the midwife. These limitations may cause some women to attempt certain positions that are unintended leading to a slip or fall. The midwife may have limited view and access while using these items during childbirth. This limitation may lead to an injury during birth. Therefore, a chair that offers the user a safe, sanitary, and comfortable means to position the body in such a way as to allow the midwife ease of access to critical areas during birth is desired.

The limitations of other chairs and household furniture may cause some women to attempt to build their own chair, however, such devices may not be very safe, sanitary or comfortable. Therefore, a chair that offers the user a safe, sanitary, and comfortable means to position the body in such a way as to allow ease of access to intimate areas to performing hygienic and depilatory rituals both in and out of the shower is desired.

Commercially available birthing beds and chairs intended for hospital use would be cost prohibitive and cumbersome in the home. Therefore, a chair that is safe, sanitary and comfortable while offering stability and support in a variety of positions both in and out of the shower whilst ensuring the midwife has visualization and access to critical areas during childbirth is desired.

### Solution

A multipurpose chair is provided. The multipurpose chair has a permanently, partially reclined seat back extending upwardly at a slight angle from the rear aspect of the solid arch shaped seat base which has a defining open front and central area. Mirroring designed disposable cushions may be present for additional comfort against the seat back and seat base. The solid arch shaped seat base includes hand notches on the front and lateral aspects of the seat base. The hand notches allow a user to grip the seat base to achieve and maintain certain positions or leverage while pushing during childbirth. The solid arched shaped seat base includes horizontally and vertically spaced heel supporting notches on the front and lateral aspects of the seat base. The heel notches allow a user to achieve and maintain seated positions with multiple degrees of knee flexion. The open center area of the arch shaped seat base provides the user access to intimate areas for shaving, waxing and steaming. The open center area of the arch shaped seat base may also be used to position steaming bowls. In addition, the open center portion of the solid arch shaped seat base provides the midwife with visualization and access to the perineum during childbirth. The solid arch shaped offers a limited degree of modesty by blocking the side and rear views of the open center area of the seat base. The seat is constructed of an antimicrobial, nonporous, hard plastic to provide for easy sanitation between uses to prevent the spread of microbes. The base foundation has a non-skid, non-slip material applied to provide safety on wet surfaces. The seat may have internal steel reinforcement to provide for additional structural integrity and durability. In this way, the chair may be utilized safely by most users during shaving, waxing, steaming and childbirth.

### BRIEF SUMMARY OF THE INVENTION

The multipurpose chair that offers a permanently partially reclined seat back extending upwardly at a slight angle from the rear of the solid arch shaped seat base with a defining open front and central area. The multipurpose chair will be constructed from one continuous piece of antimicrobial, nonporous, hard plastic such that no crevices are created that could harbor pathogens. The design provides the user with a comfortable, sanitary, stable supported means to position the body in such a way as to allow ease of access of intimate areas for activities such as shaving, waxing and steaming. The chair design also assists the woman to achieve a variety of positions that may promote a natural childbirth whilst maintaining ease of access to critical areas by the midwife. The solid arch shaped seat base provides stable support of a woman's body while positioning her legs apart with the knees in varying degrees of flexion. The woman may modify this position by facing forward, backwards or sideways. The lack of arm rests in the design was intentional to allow the midwife or support person unobstructed access to the woman during labor to provide comfort through touch, embrace and physical support. The open front and central area of the seat base provides the midwife direct visualization and access to the perineum during childbirth. The solid arch shape offers limited modesty by blocking the side and rear view of the open central area of the seat base.

### BRIEF DESCRIPTION OF THE VIEW/S OF THE DRAWING

FIG. 1

FIG. 1 shows a perspective view of an embodiment of the multipurpose chair.

The multipurpose chair will be constructed from one continuous piece of antimicrobial, nonporous, hard plastic such that no crevices are created that could harbor pathogens. In such an embodiment proper sanitation of the multipurpose chair can be accomplished easily between uses. In this embodiment, the seat base includes hand grip notches and heel supporting notches. In the shown embodiment, there are hand grips on the front and lateral aspects of the seat base. The hand grips are intended to provide the user with traction or leverage in a variety of positions. In the shown embodiment, there are paired heel supporting notches disposed at two different heights on the front and side aspects of the seat base. The heel supporting notches are intended to provide various degrees of knee flexion in the variety of positions the women may choose to achieve. In the shown embodiment, there is a front and central opening in the seat base. The front and central portion of the seat base provides the user visual and physical access to intimate areas during shaving, waxing, steaming and childbirth. In this embodiment, the bottom aspect of the seat base will comprise of a non-skid, non-slip material such that it will not slip or slide on flooring or wet surfaces, such as in a shower. This non-skid, non-slip material is intended to prevent movement of the chair, thereby, preventing potential harm or injury to the user. In another embodiment the hard plastic can further be reinforced with steel internally to provide further strength and durability of the material.

The foregoing descriptions of specific embodiments of the present invention have been presented for purposes of illustration and description. They are not intended to be exhaustive or to limit the present invention to the precise forms disclosed, and obviously many modifications and variations are possible. The embodiment was chosen and described in order to best explain the principles of the present invention and its practical application, to thereby enable others skilled in the art to best utilize the present invention and various embodiments with various modifications as are suited to the particular use contemplated.

### DETAILED DESCRIPTION OF THE INVENTION

### Background of the Invention

### Problem

Some women may wish to perform hygienic and depilatory rituals such as shaving, waxing and steaming. Such women utilizing a standard chair or shower seat may find their ability to assume certain positions necessary to shave, wax or steam intimate areas are limited. This limitation may cause some women to attempt certain positions that are unintended while using a standard chair or shower seat. This unintended use may lead to a slip or fall, potentially causing significant harm. In addition, the limitations of other chairs may cause some women to attempt to build their own chair, however, such devices may not be very safe, sanitary or comfortable. Therefore, a chair that offers the user a sanitary, comfortable, stable supported means to position the body in such a way as to allow ease of access of intimate areas to performing hygienic and depilatory rituals both in and out of the shower is desired.

The field of Midwifery and the goal of each Midwife is to provide comfort and assistance to women across their lifespan, inclusive of the time during childbirth. Many women prefer a natural childbirth but struggle to find comfortable positions that would promote a natural birth. Women who labor at home may use an inflatable device, bed, furniture, shower seat, toilet or other household furniture to find a comfortable position during childbirth. Such women utilizing these commonly found items in the home may find limitations in their ability to assume certain positions whilst maintaining direct access of critical areas to the midwife. These limitations may cause some women to attempt certain positions that are unintended leading to a slip or fall. The midwife may have limited view and access while using these items during childbirth. This limitation may lead to an injury during birth. Therefore, a chair that offers the user a safe, sanitary, and comfortable means to position the body in such a way as to allow the midwife ease of access to critical areas during birth is desired.

Commercially available birthing beds and chairs intended for hospital use would be cost prohibitive and cumbersome in the home. Therefore, a chair that is safe, sanitary and comfortable while offering stability and support in a variety of positions both in and out of the shower whilst ensuring the midwife has visualization and access to critical areas during childbirth is desired.

### Solution

A multipurpose chair is provided. The multipurpose chair has a permanently, partially reclined seat back extending upwardly at a slight angle from the rear aspect of the solid arch shaped seat base which has a defining open front and central area. Mirroring designed disposable cushions may be present for additional comfort against the seat back and seat base. The solid arch shaped seat base includes hand notches on the front and lateral aspects of the seat base. The hand notches allow a user to grip the seat base to achieve and maintain certain positions or leverage while pushing during childbirth. The solid arched shaped seat base includes horizontally and vertically spaced heel supporting notches on the front and lateral aspects of the seat base. The heel notches allow a user to achieve and maintain seated positions with multiple degrees of knee flexion. The open central area of the arch shaped seat base provides the user access to intimate areas for shaving, waxing and steaming. The open center area of the arch shaped seat base may also be used to position steaming bowls.

The chair design assists the woman to achieve a variety of positions that may promote a natural childbirth. The solid arch shaped seat base provides stable support of a woman's body while positioning her legs apart with varying degrees of flexion in the knees. The woman may modify this position by facing forward, backwards or sideways. The lack of arm rests in the design was intentional to allow the midwife or support person unobstructed access to the woman during labor to provide comfort through touch, embrace and physical support. In addition, the open central portion of the solid arch shaped seat base ensures the midwife has visualization and access to the critical areas during childbirth. The solid arch shape offers a limited degree of modesty by blocking the side and rear views of the center area of the seat base.

The seat is constructed of an antimicrobial, nonporous, hard plastic to provide for easy sanitation between uses to prevent the spread of microbes. The seat may have internal steel reinforcement to provide for additional structural integrity and durability for use in both the private and commercial sectors. In this way, the chair may be utilized safely by most users during shaving, waxing, steaming and childbirth.

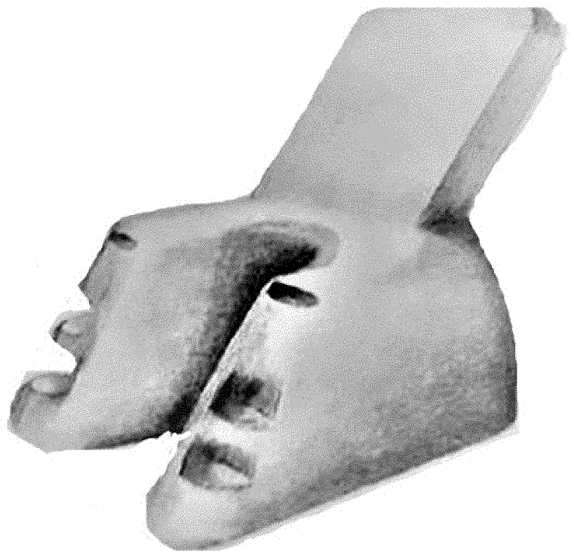

Referring now to FIG. 1, an embodiment of a perspective view of the multipurpose chair. The multipurpose chair will be constructed from one continuous piece of antimicrobial, nonporous, hard plastic such that no crevices are created that could harbor pathogens. In such an embodiment proper sanitation of the multipurpose chair can be accomplished easily between uses. In this embodiment, the seat base includes hand grip notches and heel supporting notches. In the shown embodiment, there are hand grips on the front and lateral aspects of the seat base. The hand grips are intended to provide the user with traction or leverage in a variety of positions. In the shown embodiment, there are six pairs of heel supporting notches disposed at two different heights on the front and lateral aspects of the seat base. The heel supporting notches are intended to provide various degrees of knee flexion in the variety of positions the women may choose to achieve. In the shown embodiment, there is a front and central opening in the seat base. The front and central portion of the seat base may provide an additional area a woman may use to adjust the positioning of her legs. In this embodiment, the bottom aspect of the seat base will comprise of a non-skid, non-slip material such that it will not slip or slide on flooring or wet surfaces, such as in a shower. This non-skid, non-slip material is intended to prevent movement of the chair, thereby, preventing potential injury. In another embodiment the hard plastic can further be reinforced with steel internally to provide further strength and durability of the material.

1) The multipurpose chair provides the user:
a) A chair that aids the user to safely access intimate areas in a variety of positions desired for hygienic or depilatory rituals.
b) A chair that is safe in both wet and dry conditions offering the user support in positions that may promote a natural childbirth.
c) A chair that is easily moved and sanitized between users.
